(19) United States
(12) Patent Application Publication
(10) Pub. No.: US 2019/0328171 A1
(43) Pub. Date: Oct. 31, 2019

(54) Blender Frothing Apparatus and Method

(71) Applicant: Hamilton Beach Brands, Inc., Glen Allen, VA (US)

(72) Inventor: Kevin L. Leppert, Lanexa, VA (US)

(21) Appl. No.: 16/386,635

(22) Filed: Apr. 17, 2019

Related U.S. Application Data
(60) Provisional application No. 62/663,681, filed on Apr. 27, 2018.

(51) Int. Cl. A47J 31/44; A47J 43/046

(52) U.S. Cl. CPC A47J 31/4496; A47J 43/046

(57) ABSTRACT

A frothing accessory for a blender comprises a main body having a sidewall and a bottom wall. The sidewall has at least a first portion having a frustoconical shape. The bottom wall is at a wider end of the main body. The frothing accessory is adapted to be attachable to a blender jar to enable the frothing accessory to be selectively rotated about a longitudinal axis.

### CROSS-REFERENCE TO RELATED APPLICATIONS

This application is a non-provisional of and claims priority to U.S. Provisional Patent Application Ser. No. 62/663,681, filed Apr. 27, 2018, the contents of which are incorporated herein by reference in its entirety.

### BACKGROUND OF THE DISCLOSURE

The present disclosure relates generally to small appliances and more particularly to a blender accessory and blender jar for frothing a liquid or mixture.

Blenders are a common household appliance and are capable of mixing liquids and chopping dry foods. Blenders are also useful for liquefying fruits and vegetables and for blending solids with liquids. A blender may include a jar that sits on top of a base or housing that encloses and controls a motor. The jar includes a blending tool rotatably mounted thereto. The blending tool is rotatably engageable with a drive shaft of the motor in an operating configuration. Foodstuff is placed into the jar and the jar is engaged with the base. The foodstuff is blended and the jar is removed from the base to dispense or pour the blended foodstuff.

Coffee drinks, such as cappuccinos, are very popular, and many people desire to make such drinks at home. One challenge with making such coffee drinks at home is frothing milk. A specialized device is often required to suitably froth milk. It would be desirable to be able to froth milk using an appliance that many consumers already own, such as a blender. However, conventional blenders do not perform as well at frothing milk as such specialized devices.

It has heretofore not been discovered how to create a blender that can froth milk suitably. The blender accessory or blender jar of the following disclosure accomplishes the above and other objectives and overcomes at least the above-described disadvantages of conventional blenders.

### BRIEF SUMMARY OF THE DISCLOSURE

A frothing accessory for a blender is disclosed herein. In one embodiment of the subject device, the frothing accessory comprises a main body having a sidewall and a bottom wall. The sidewall has at least a first portion having a frustoconical shape. The bottom wall is at a wider end of the main body. The frothing accessory is adapted to be attachable to a blender jar to enable the frothing accessory to be selectively rotated about a longitudinal axis.

The sidewall may further have a second portion. The second portion has a concave-frustoconical shape. The second portion of the sidewall is further from the bottom wall than the first portion of the sidewall.

An angle of the first portion of the sidewall relative to the longitudinal axis of the frothing accessory may be between 40 and 50 degrees. The angle may be 45 degrees.

A center hole may be defined in the bottom wall. The center hole provides an opening to a central cavity within the main body adapted for receiving a rotatable post of the blender jar for attaching the frothing accessory to the blender jar.

The frothing accessory may further comprise a center core extending longitudinally through the main body. The center core is constructed of a different material than the main body. A center hole is defined in a bottom end of the center core. The center hole provides an opening to a central cavity within the center core for receiving a rotatable post of the blender jar for attaching the frothing accessory to the blender jar.

A grasping portion may project upwardly from a top end of the frothing accessory.

In alternative embodiments of the present disclosure, a blender jar comprises a container portion having a floor, a selectively rotatable post extending upward from the floor, and a frothing accessory as described above that is selectively attachable to the rotatable post such that the frothing accessory selectively rotates about a longitudinal axis when the rotatable post selectively rotates.

Other alternative embodiments of the invention comprise a method of frothing a liquid in a blender having a blender jar. The method comprises attaching a frothing accessory as described above to a selectively rotatable post extending upward from a floor of a container portion of the blender jar, placing the liquid to be frothed into the blender jar, securing a lid onto an open top end of the blender jar, and activating the blender to selectively rotate the rotatable post such that the attached frothing accessory in turn rotates about a longitudinal axis of the frothing accessory.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a perspective view of a blender with a frothing accessory, according to one embodiment of the present disclosure.

FIG. 2 is a perspective view of the blender of FIG. 1, with the frothing accessory removed.

FIG. 3 is a top perspective view of the frothing accessory of FIG. 1.

FIG. 4 is a bottom perspective view of the frothing accessory of FIG. 1.

FIG. 5 is a front view of the frothing accessory of FIG. 1.

FIG. 6 is a side view of the frothing accessory of FIG. 1.

FIG. 7 is a top view of the frothing accessory of FIG. 1.

FIG. 8 is a bottom view of the frothing accessory of FIG. 1.

FIG. 9 is a front cross-sectional view of the frothing accessory of FIG. 1.

FIGS. 10-12 are front views of frothing accessories of alternative embodiments of the present disclosure.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

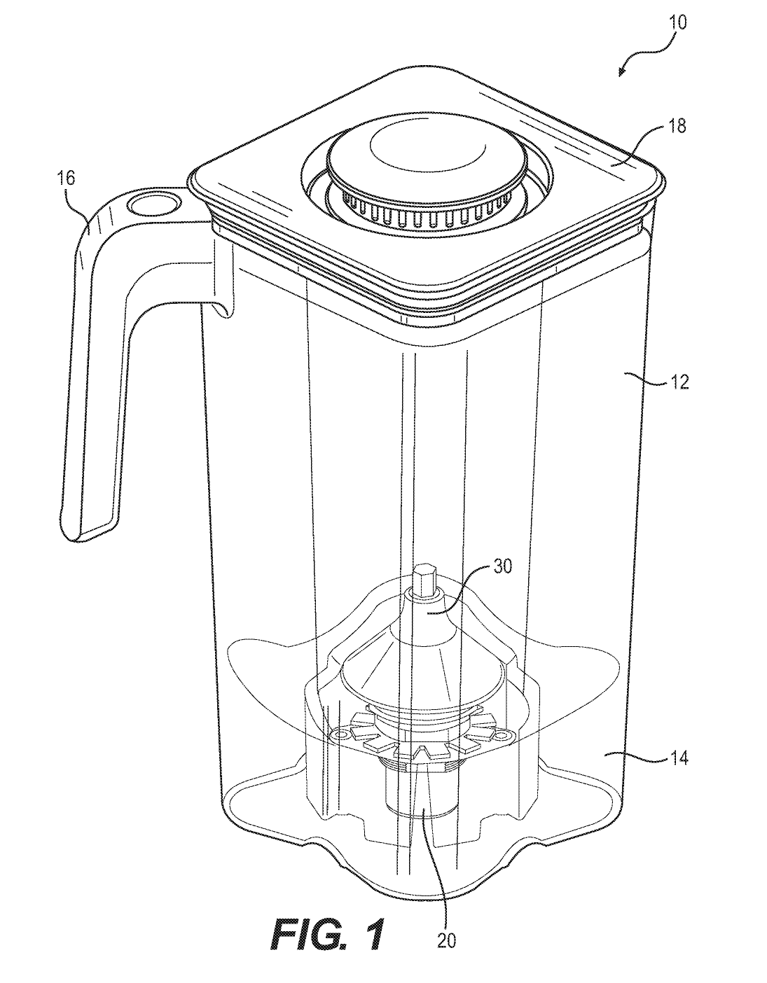

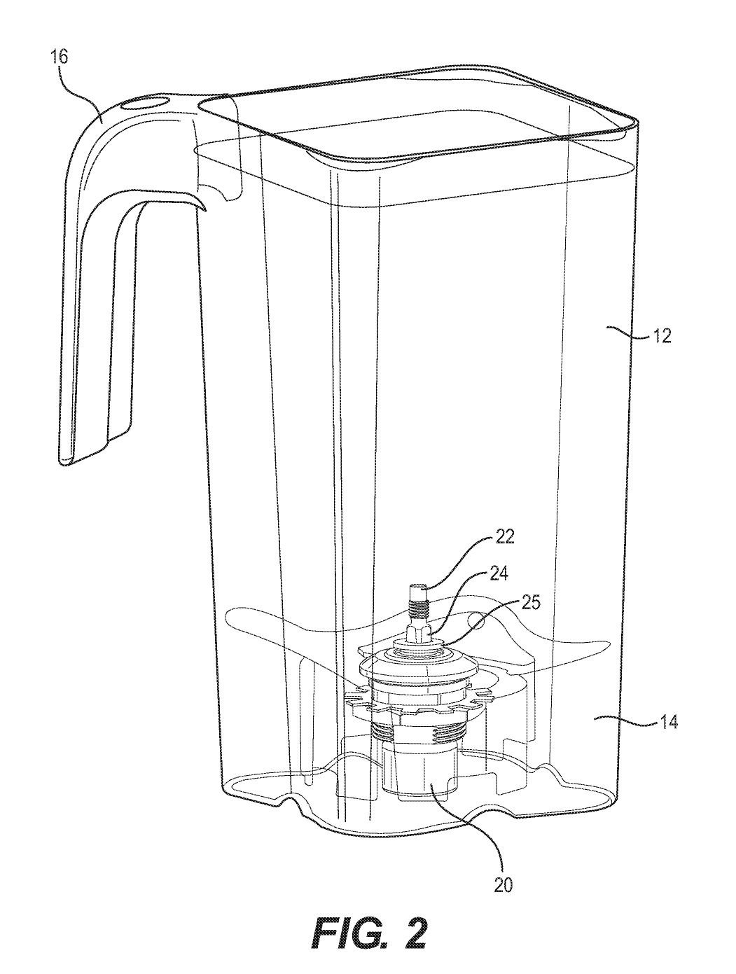

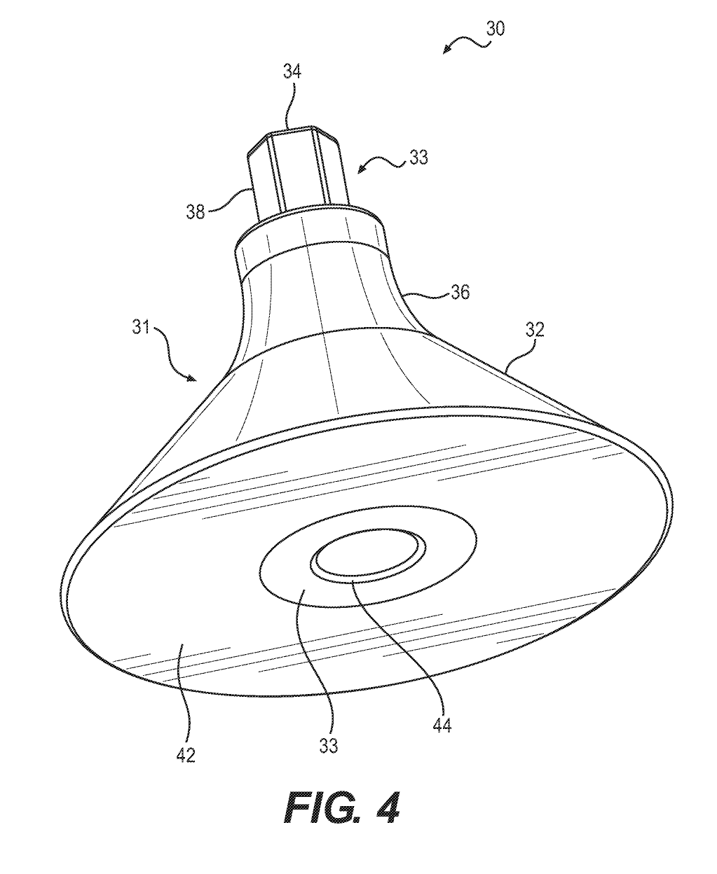

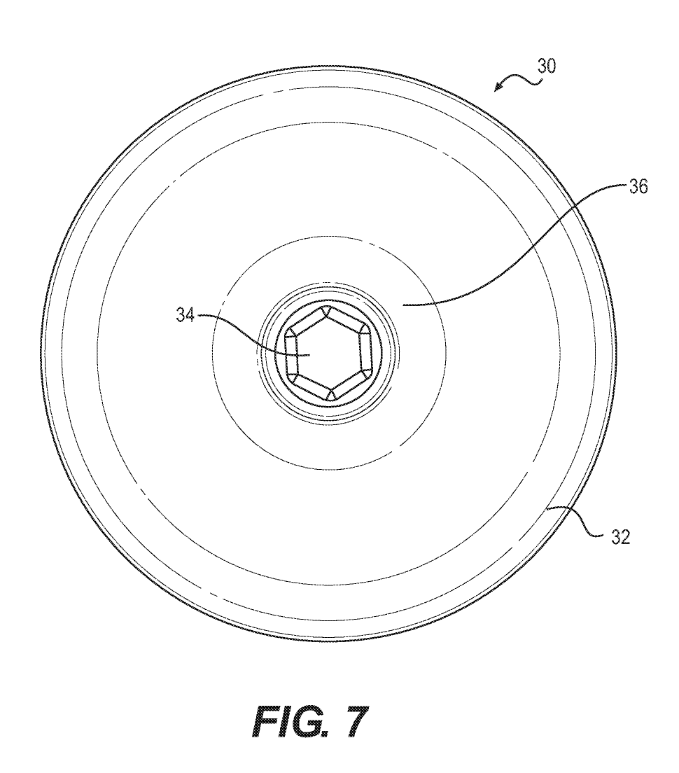

Embodiments of the present disclosure comprise a frothing accessory or attachment for a blender, a blender having such a frothing accessory, and a corresponding method of frothing milk using the frothing accessory disclosed herein. Referring to the drawings in detail, wherein like numerals indicate like elements throughout, FIGS. 1-9 illustrate a blender and frothing accessory of an embodiment of the present disclosure. FIG. 1 illustrates a blender jar 10 with the frothing attachment/accessory in place for frothing milk (or any other suitable beverage. The blender jar 10 comprises a container portion 12 for holding a liquid to be frothed, a bottom portion 14 for removably mounting the blender jar to a base (not illustrated) that houses a motor (not illustrated), a conventional drive mechanism 20 for rotating conventional blades (not illustrated) or a frothing accessory 30 when the motor is activated, a lid 18, and a handle 16. The blender jar may be a conventional blender jar, in which the blades are removable and the novel frothing accessory selectively attached in place of the blades. Alternatively, the blender jar may utilize only the novel frothing accessory (which therefore may be permanently attached to the blender jar). FIG. 2 illustrates the blender jar with the blades removed. A motor in the base rotates, via the drive mechanism 20, a threaded post 22 to which either conventional blades or the novel frothing accessory 30 may be selectively attached. The threaded post 22 has a larger square base 24. A spacing washer 25 may be positioned at the base of the threaded post 22 so that the washer 25 surrounds the square base 24. The washer 25 provides a slight elevation of the frothing accessory above the drive mechanism 20, while also providing some protection from liquid in the container portion 12 from reaching the threaded post 22. The attachment of the frothing accessory 30 to the threaded post 22 is described below. FIG. 2 shows one possible structure for selectively attaching a frothing accessory to a blender jar, however many other suitable structures are possible and may be used instead of the illustrated structure.

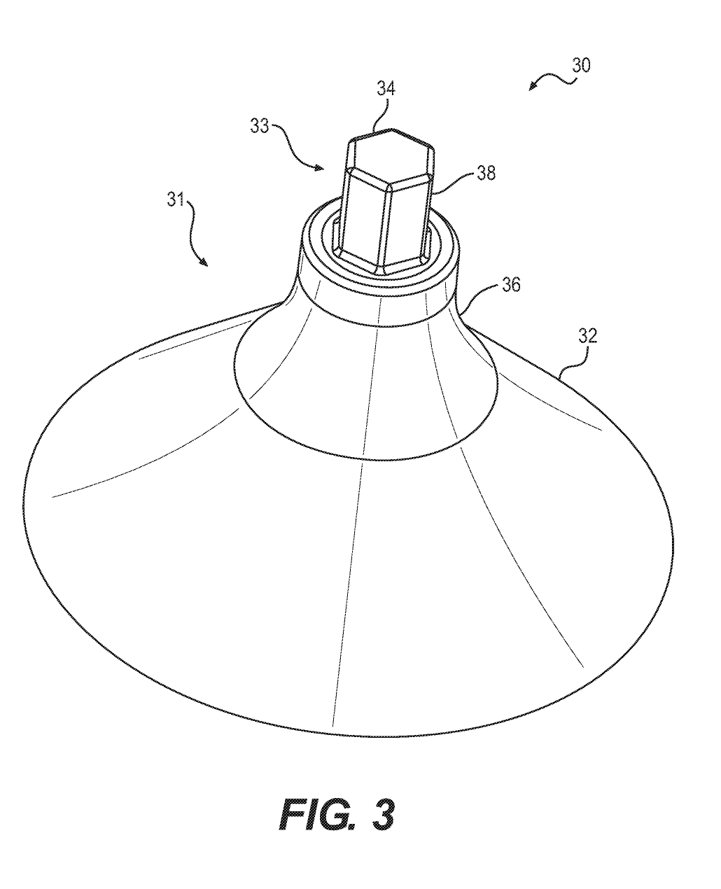

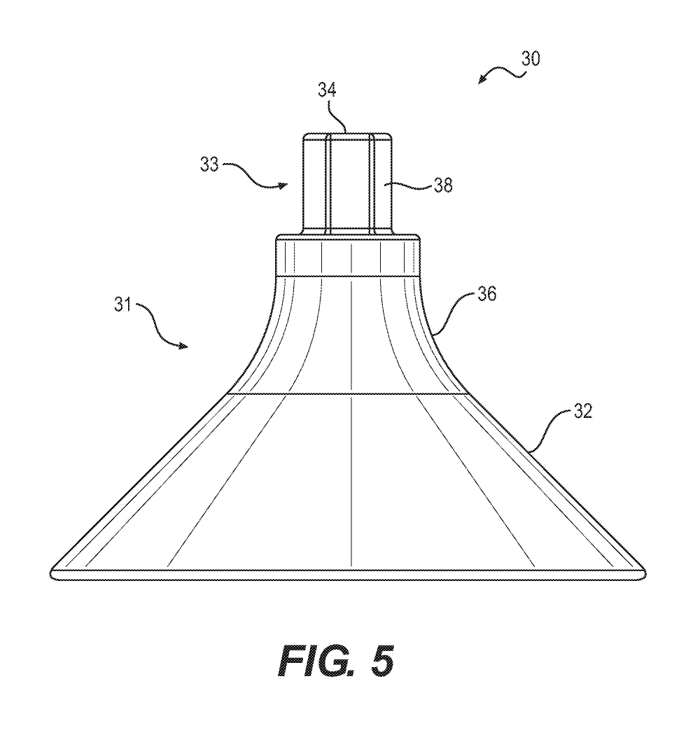

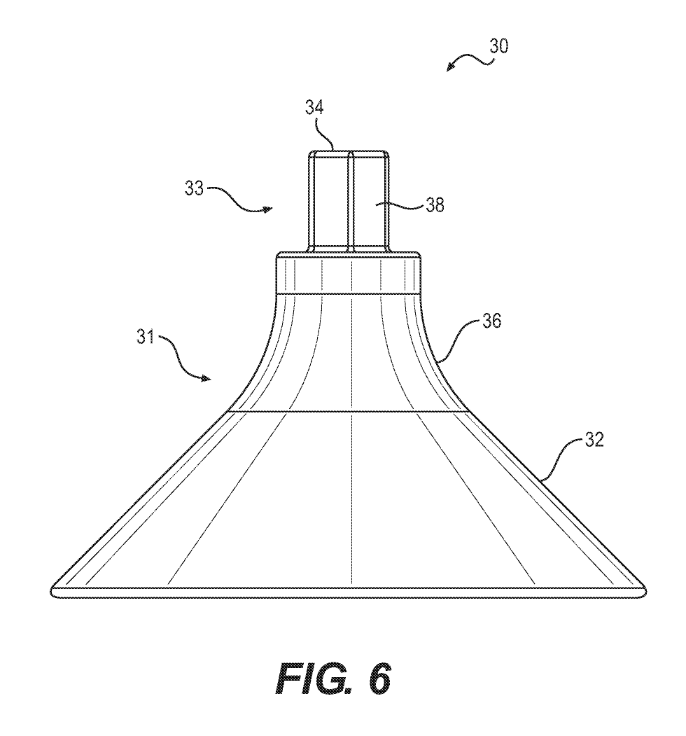

FIGS. 3-9 illustrate various views of the frothing accessory 30 removed from the blender jar. In the illustrated embodiment, the frothing accessory 30 is generally bell shaped, but with a planar bottom surface 42 (except for mounting hole 44, described further below). The frothing accessory 30 comprises a main body 31 surrounding a center core 33. The center core 33 is typically constructed of any suitable metal (for strength), while the main body 31 is typically constructed of any suitable plastic that is overmolded onto the center core 33. (In alternative embodiments, the frothing accessory may be a unitary structure constructed entirely out of a single material (e.g., plastic or metal).) The main body 31 of the frothing accessory 30 comprises a lower flared section 32 which has straight edges when viewed from any side (see FIGS. 5 and 6) (such a shape may also be described as frustoconical) and an inwardly curved (i.e., curved toward the longitudinal axis of the device) upper section 36 (such as shape may also be described as concave; the shape of the upper section 36 may also be described as concave-frustoconical). An upright post section 34 of the center core 33 projects upward from the top end of the main body 31. The post section 34 may have two or more opposing flat sections 38. (In the illustrated embodiment, the post section 34 is hexagonal, so there are three pairs of opposing flat sections 38.) The opposing flat sections 38 enable a user to readily grasp and turn the frothing accessory 30 to selectively attach or remove the frothing accessory 30 from the threaded post 22 (any other suitable structure (or no structure) may be used to enable a user to readily grasp and turn the frothing accessory).

In the illustrated embodiments, the surfaces (primarily of the lower flared section 32 and the bottom surface 42, but potentially also of the curved section 36 and/or the post section 34) of the frothing accessory 30 are smooth. The smooth surfaces create a shear between the surfaces and the liquid (e.g., milk) to create bubbles that impart a froth to the liquid. In other embodiments of the invention (not illustrated), some or all of the surfaces may be textured (e.g., stippled).

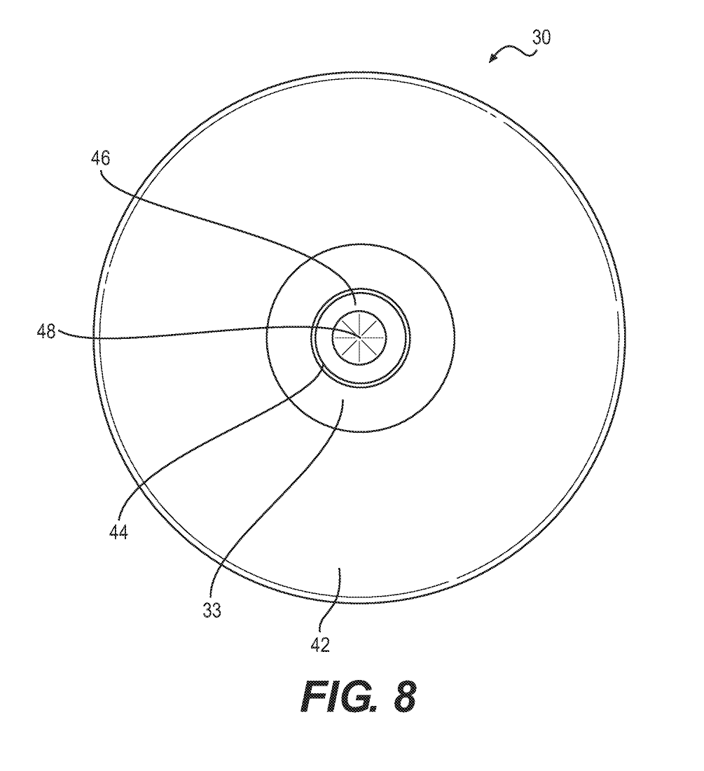

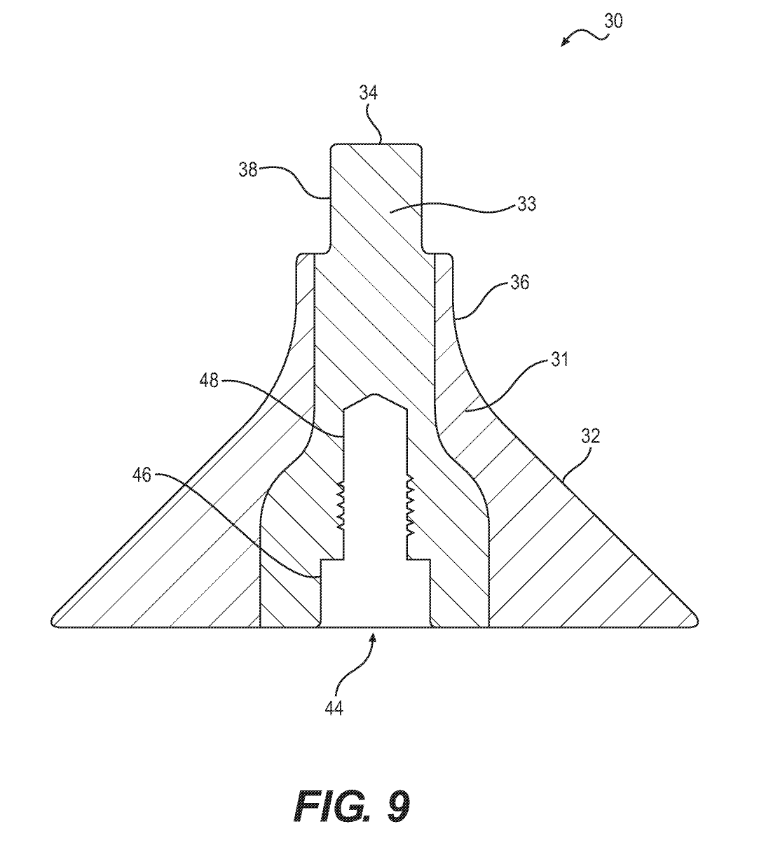

As seen in FIGS. 8 and 9, the mounting hole 44 is centrally located in the bottom surface 42 and comprises a wider first (or lower) portion 46 and a threaded second (or upper) portion 48. The threaded second portion 48 receives the threaded post 22 to attach the frothing accessory 30 to the threaded post 22. The wider first portion 46 is sized to receive but not contact the square base 24 to enable the frothing accessory 30 to be screwed onto the threaded post 22. In this regard, the frothing accessory 30 is readily attached to the blender in place of the conventional blades and the frothing accessory 30 is supported from the bottom in an upright position within the blender jar to enable frothing of a liquid within the blender jar.

The embodiment illustrated in FIGS. 1-9 has an overall height of 50 millimeters (mm), a diameter of the bottom surface 42 of about 70 mm, a diameter of the post section 34 of about 10 mm, an angle of the lower flared section 32 of about 45 degrees (measured either from the longitudinal axis or from the bottom surface 42), and a radius of the curvature of the curved section 36 of about 18 mm (any or all of these specific dimensions, angles, etc. may vary). For example, the angle of the lower flared section 32 may be between 30 and 60 degrees, or between 40 and 55 degrees.

The frothing accessory of embodiments of the present disclosure is typically constructed of one or more solid materials that are rigid, durable, and impermeable to liquid, such as any suitable metal or any suitable plastic.

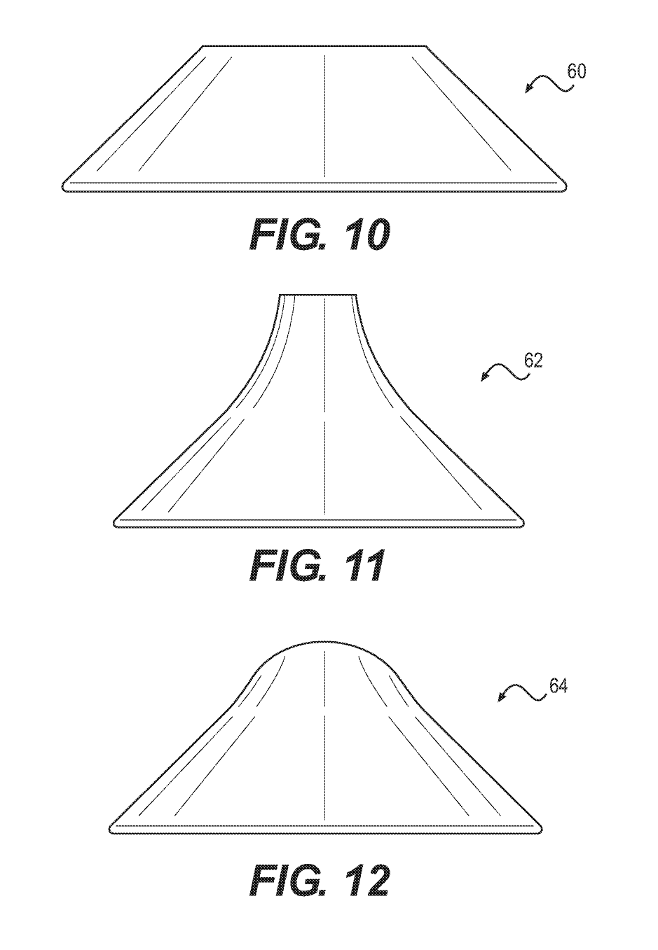

FIG. 10 illustrates a frothing accessory 60, according to an alternative embodiment of the present disclosure. The frothing accessory 60 is similar to the frothing accessory 30 of FIGS. 1-9, except that the frothing accessory 60 comprises only the lower flared section. The frothing accessory 60 has a planar top surface (although it could optionally have a semispherical top surface) and a planar bottom surface (except for a mounting hole as in frothing accessory 30).

FIG. 11 illustrates a frothing accessory 62, according to an alternative embodiment of the present disclosure. The frothing accessory 62 is similar to the frothing accessory 30 of FIGS. 1-9, except that the frothing accessory 62 comprises only the lower flared section and the curved section. The frothing accessory 62 has a planar top surface (although it could optionally have a semispherical top surface) and a planar bottom surface (except for a mounting hole as in frothing accessory 30).

FIG. 12 illustrates a frothing accessory 64, according to an alternative embodiment of the present disclosure. The frothing accessory 64 is similar to the frothing accessory 30 of FIGS. 1-9, except that the frothing accessory 64 comprises only the lower flared section capped by a semispherical top surface. The frothing accessory 60 has a planar bottom surface (except for a mounting hole as in frothing accessory 30).

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

That which is claimed:

1. A frothing accessory for a blender comprises:
a main body having a sidewall and a bottom wall, the sidewall having at least a first portion having a frustoconical shape, the bottom wall being at a wider end of the main body;
wherein the frothing accessory is adapted to be attachable to a blender jar to enable the frothing accessory to be selectively rotated about a longitudinal axis.

2. The frothing accessory of claim 1, wherein the sidewall further has a second portion, the second portion having a concave-frustoconical shape, the second portion of the sidewall being further from the bottom wall than the first portion of the sidewall.

3. The frothing accessory of claim 1, wherein an angle of the first portion of the sidewall relative to the longitudinal axis of the frothing accessory is between 40 and 50 degrees.

4. The frothing accessory of claim 3, wherein an angle of the first portion of the sidewall relative to the longitudinal axis of the frothing accessory is 45 degrees.

5. The frothing accessory of claim 1, wherein a center hole is defined in the bottom wall, the center hole providing an opening to a central cavity within the main body adapted for receiving a rotatable post of the blender jar for attaching the frothing accessory to the blender jar.

6. The frothing accessory of claim 1, further comprising a center core extending longitudinally through the main body, the center core being constructed of a different material than the main body, a center hole being defined in a bottom end of the center core, the center hole providing an opening to a central cavity within the center core for receiving a rotatable post of the blender jar for attaching the frothing accessory to the blender jar.

7. The frothing accessory of claim 1, further comprising a grasping portion projecting upwardly from a top end of the frothing accessory.

8. A blender jar comprising:
a container portion having a floor;
a selectively rotatable post extending upward from the floor; and
a frothing accessory selectively attachable to the rotatable post such that the frothing accessory selectively rotates about a longitudinal axis when the rotatable post selectively rotates, the frothing accessory comprising a main body having a sidewall and a bottom wall, the sidewall having at least a first portion having a frustoconical shape, the bottom wall being at a wider end of the main body.

9. The blender jar of claim 8, wherein the sidewall of the frothing accessory further has a second portion, the second portion having a concave-frustoconical shape, the second portion of the sidewall being further from the bottom wall than the first portion of the sidewall.

10. The blender jar of claim 8, wherein an angle of the first portion of the sidewall of the frothing accessory relative to the longitudinal axis of the frothing accessory is between 40 and 50 degrees.

11. The blender jar of claim 10, wherein an angle of the first portion of the sidewall of the frothing accessory relative to the longitudinal axis of the frothing accessory is 45 degrees.

12. The blender jar of claim 8, wherein a center hole is defined in the bottom wall of the frothing accessory, the center hole providing an opening to a central cavity within the main body of the frothing accessory for receiving a rotatable post of the blender jar for selectively attaching the frothing accessory to the blender jar.

13. The blender jar of claim 8, further comprising a center core extending longitudinally through the main body, the center core being constructed of a different material than the main body, a center hole being defined in a bottom end of the center core, the center hole providing an opening to a central cavity within the center core for receiving the rotatable post of the blender jar for attaching the frothing accessory to the blender jar.

14. The blender jar of claim 8, wherein the frothing accessory further comprises a grasping portion projecting upwardly from a top end of the frothing accessory.

15. A method of frothing a liquid in a blender having a blender jar, the method comprising:
attaching a frothing accessory to a selectively rotatable post extending upward from a floor of a container portion of the blender jar, the frothing accessory comprising a main body having a sidewall and a bottom wall, the sidewall having at least a first portion having a frustoconical shape, the bottom wall being at a wider end of the main body;
placing the liquid to be frothed into the blender jar;
securing a lid onto an open top end of the blender jar; and
activating the blender to selectively rotate the rotatable post such that the attached frothing accessory in turn rotates about a longitudinal axis of the frothing accessory.

16. The method of claim 15, wherein the sidewall of the frothing accessory further has a second portion, the second portion having a concave-frustoconical shape, the second portion of the sidewall being further from the bottom wall than the first portion of the sidewall.

17. The method of claim 15, wherein an angle of the first portion of the sidewall of the frothing accessory relative to the longitudinal axis of the frothing accessory is between 40 and 50 degrees.

18. The method of claim 17, wherein an angle of the first portion of the sidewall of the frothing accessory relative to the longitudinal axis of the frothing accessory is 45 degrees.

19. The method of claim 15, wherein a center hole is defined in the bottom wall of the frothing accessory, the center hole providing an opening to a central cavity within the main body of the frothing accessory for receiving a rotatable post of the blender jar for attaching the frothing accessory to the blender jar.

20. The method of claim 15, further comprising a center core extending longitudinally through the main body, the center core being constructed of a different material than the main body, a center hole being defined in a bottom end of the center core, the center hole providing an opening to a central cavity within the center core for receiving the rotatable post of the blender jar for attaching the frothing accessory to the blender jar.
